(19) United States
(12) Patent Application Publication
(10) Pub. No.: US 2024/0004680 A1
(43) Pub. Date: Jan. 4, 2024

(54) CPU Core Off-parking

(71) Applicant: Microsoft Technology Licensing, LLC, Redmond, WA (US)

(72) Inventors: Peter JIANG, Kirkland, WA (US); Drew CROSS, Bothell, WA (US); Taylor Marie POTHAST, Seattle, WA (US); Bruce J. SHERWIN, JR., Woodinville, WA (US); Robert Sommer CHAPPELL, Mercer Island, WA (US)

(73) Assignee: Microsoft Technology Licensing, LLC, Redmond, WA (US)

(21) Appl. No.: 17/809,683

(22) Filed: Jun. 29, 2022

(51) Int. Cl. G06F 9/455

(52) U.S. Cl. CPC G06F 9/45558; G06F 2009/45591; G06F 2009/4557

(57) ABSTRACT

Examples of the present disclosure describe systems and methods for CPU core off-parking. In one example implementation, a performance test is executed for a CPU core that is part of a first mapping of virtual processors to logical CPU cores. A set of performance indicators is received for the CPU core. Based on the set of performance indicators, a determination is made regarding whether to off-park the CPU core. If it is determined that the CPU core is to be off-parked, a second mapping of virtual processors to logical CPU cores is created, where the CPU core to be off-parked is not part of the second mapping. The second mapping is then implemented.

### BACKGROUND

There are a number of hardware issues that may occur on central processing unit (“CPU”) hardware. Many of these hardware issues occur on CPU cores, which increase the chance of errors and failures when running workloads on those CPU cores. Currently, the solution for such hardware issues is to replace the entire CPU socket comprising the CPU experiencing the hardware issue. However, the CPU socket comprises numerous CPU cores, most of which will not be experiencing hardware issues. As such, replacing the entire CPU socket is often wasteful and unnecessarily costly.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for CPU core off-parking. In one example implementation, a performance test is executed for a CPU core that is part of a first mapping of virtual processors to logical CPU cores. A set of performance indicators is received for the CPU core. Based on the set of performance indicators, a determination is made regarding whether to off-park the CPU core. If it is determined that the CPU core is to be off-parked, a second mapping of virtual processors to logical CPU cores is created, where the CPU core to be off-parked is not part of the second mapping. The second mapping is then implemented.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an example host device for CPU core off-parking.

FIG. 2A illustrates a first example mappings of virtual processors to logical CPU cores.

FIG. 2B illustrates a second example mappings of virtual processors to logical CPU cores.

FIG. 3 illustrates an example method for CPU core off-parking.

FIG. 4 is a block diagram illustrating example physical components of an input processing unit for executing one or more aspects of the present disclosure.

FIGS. 5A and 5B are an illustration and a simplified block diagram, respectively, of an example mobile computing device for practicing aspects of the present disclosure.

FIG. 6 is a simplified block diagram of an example distributed computing system for practicing aspects of the present disclosure.

FIG. 7 illustrates an example tablet computing device for executing one or more aspects of the present disclosure.

### DETAILED DESCRIPTION

Hardware virtualization is the abstraction of computing resources and functionality from physical hardware. One example of hardware virtualization includes the implementation of virtual machines (VMs). A VM is a computing resource that uses software instead of a physical hardware to run programs and deploy applications. A VM is capable of processing a workload that comprises applications and processes that could be similarly run on a physical machine. A VM is deployed on a host device and is managed by a hypervisor or a similar hardware/software emulator component of the host device. The hypervisor maps the virtual processors of the VM to logical central processing unit (CPU) cores of the host device. The logical CPU cores represent the number of physical CPU cores of physical CPUs of the host device times the number of threads that can be executed on each physical CPU core. The hypervisor also allocates workloads to the virtual processors of the VM.

Numerous issues occur with CPU hardware, including hardware defects of the physical CPUs. For example, one or more physical CPU cores of a physical CPU may become damaged over time. The hardware defects increase the occurrence of errors and failures while workloads are being processed by the virtual processors of the VM. Currently, a solution for handling hardware defects for a physical CPU is to replace the entire CPU socket for the physical CPU. A CPU socket is the physical connector on the motherboard in which the physical CPU fits. Replacing the CPU socket includes replacing the physical CPU fitted to the CPU socket. This solution is problematic because most current physical CPU comprise numerous physical CPU cores, only one of which may be experiencing hardware issues. As such, replacing the entire CPU socket is often wasteful (of the non-defective physical CPU cores), expensive (as CPU socket replacement is expensive), and disruptive (as the device comprising the CPU must be taken down to be serviced.

The present disclosure provides a solution that avoids unnecessarily replacing entire CPU sockets when a physical CPU core is defective. Specifically, the present disclosure describes systems and methods for CPU core off-parking. In examples, a performance test is executed on a physical CPU core that is part of a first mapping of virtual processors to logical CPU cores. The performance test is executed using testing software of a computing device and may be initiated manually by a user or as part of an automated process by a component of the computing device, such as an OS kernel, a hypervisor, or a processor power management component. The performance test may consider metrics, such as availability, response time, channel capacity, latency, completion time, service time, bandwidth, throughput, relative efficiency, scalability, performance per watt, compression ratio, and instruction path length. The performance test may also consider the number of errors reported by the physical CPU core, the frequency of errors reported the physical CPU core, the length of the time the physical CPU core has been in use, and other factors.

In response to the performance test, a set of performance indicators is received for the physical CPU core from the testing software. The performance indicators are indicative of the current and/or historical performance of the physical CPU core. Based on the set of performance indicators, a determination is made regarding whether the physical CPU core is to be off-parked. Off-parking, as used herein, refers to dynamically disabling a physical CPU core or preventing workloads from being provided to and processed by the physical CPU core. If it is determined that the physical CPU core is to be off-parked, a second mapping of virtual processors to logical CPU cores is created, where the physical CPU core to be off-parked is not part of the second mapping. For example, the virtual processors that were mapped to the logical CPU cores of the physical CPU core to be off-parked are remapped to the logical CPU cores of one or more different physical CPU cores. The second mapping is then implemented such that the physical CPU core is off-parked. This remapping of virtual processors to logical CPU cores enables defective physical CPU cores to be removed from workload processing without impact to the VM. The remapping also prevents significant impact to the host device implementing the VM, as the processing responsibilities of the off-parked physical CPU core are spread over the remaining physical CPU cores of the host device.

Accordingly, the present disclosure provides a plurality of technical benefits and improvements over previous solution for handling hardware defects for CPUs. These technical benefits and improvements include: dynamic off-parking of CPUs indicating a history of hardware failure or a likelihood that failure or error is imminent, dynamically remapping virtual processors of a VM to logical CPU cores of a host device to enable a host device to effectively ignore a defective physical CPU core, reducing the number of errors generated by VMs during workload processing, reducing the expense of maintaining CPU hardware, and increasing the functional lifetime of CPU hardware, among other examples.

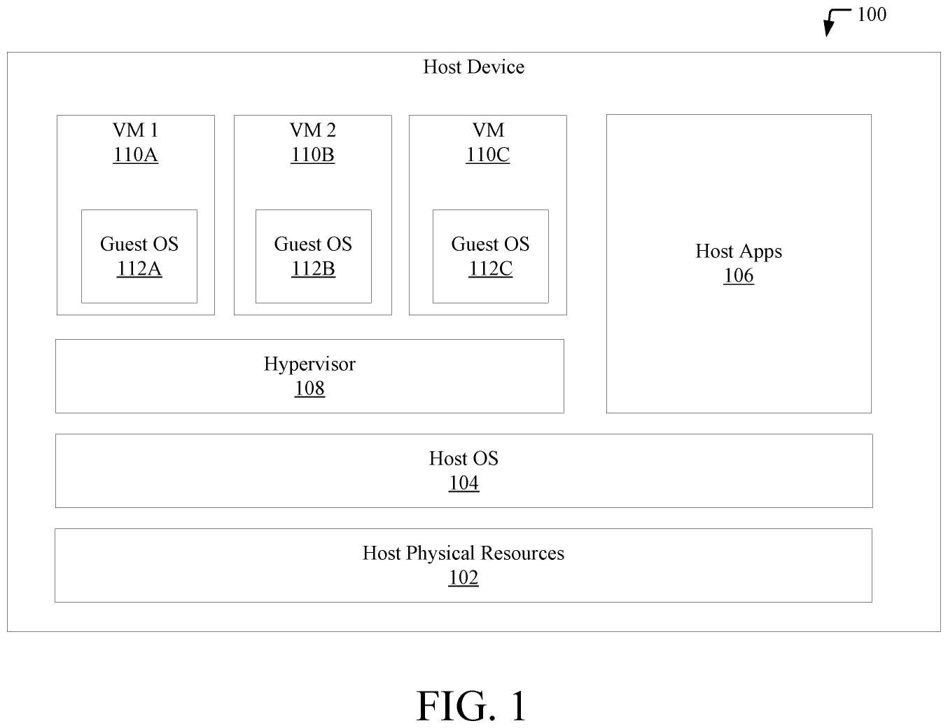

FIG. 1 illustrates a host device for CPU core off-parking. Example host device 100 as presented is a combination of interdependent components that interact to form an integrated whole. Components of host device 100 may be hardware components or software components (e.g., applications, application programming interfaces (APIs), modules, VMs, or runtime libraries) implemented on and/or executed by hardware components of host device 100. In one example, components of host device 100 are distributed across multiple processing devices.

In FIG. 1, host device 100 comprises host physical resources 102, host OS 104, host applications 106, hypervisor 108, and VMs 110A, 110B, and 110C (collectively referred to as “VM(s) 110”). The scale and structure of devices, environments, and systems discussed herein may vary and may include additional or fewer components than those described in FIG. 1 and subsequent figures. Further, although examples in FIG. 1 and subsequent figures will be discussed in the context of VMs, the examples are equally applicable to other contexts, such as containers (or other virtual resources) and those contexts that do not implement virtual environments or virtual components. Further still, although examples in FIG. 1 and subsequent figures will be discussed in the context of off-parking physical CPUs, the examples are equally applicable to off-parking virtual processors. Examples of host device 100 include personal computers (PCs), server devices, mobile devices (e.g., smartphones, tablets, laptops, personal digital assistants (PDAs)), wearable devices (e.g., smart watches, smart eyewear, fitness trackers, smart clothing, body-mounted devices, head-mounted displays), gaming consoles or devices, and Internet of Things (IoT) devices.

Host physical resources 102 include processing hardware (e.g., a central processing unit (CPU), a graphics processing unit (GPU), a video card), memory, persistent storage, a network interface, and the like. In examples, host physical resources 102 are directly accessible by host OS 104, host applications 106, and hypervisor 108, and are not directly accessible by VM(s) 110. Instead, VM(s) 110 indirectly access host physical resources 102 via a component of host device 100, such as hypervisor 108.

Host OS 104 provides software for performing various computing functions, such as executing host applications 106, executing hypervisor 108, scheduling tasks, and controlling peripherals (e.g., microphones, touch-based sensors, geolocation sensors, accelerometers, optical/magnetic sensors, gyroscopes, keyboards, and pointing/selection tools). Host OS 104 receives input data (e.g., audio input, touch input, text-based input, gesture input, and/or image input) from a user or a computing device. In some examples, the input data corresponds to user interaction with host applications 106 or hypervisor 108. In other examples, the input data corresponds to automated interaction with services or host applications 106, such as the automatic (e.g., non-manual) execution of scripts or sets of commands at scheduled times or in response to predetermined events.

Host applications 106 may be implemented locally on host device 100 or accessible remotely by host device 100 via a network, such as a private area network (PAN), a local area network (LAN), a wide area network (WAN), and the like. In some examples, host applications 106 are virtualized using a virtualization component of host device 100, such as hypervisor 106. Host applications 106 provide access to a set of software and/or hardware functionality. Examples of host applications 106 include applications and services relating to word processing, spreadsheets, presentation software, document-reading, social media software or platforms, search engines, media software or platforms, multimedia players, content design software or tools, database software or tools, provisioning software, and alert or notification software.

Hypervisor 108 is software that creates, executes, and manages VM(s) 110 within an execution environment of host device 100. Hypervisor 108 exposes VM(s) 110 to one or more networks in order to enable VM(s) 110 to communicate amongst each other and to communicate with other devices or components of or external to host device 100. In examples, hypervisor 108 provides VM(s) 110 access to host physical resources 102 and/or the physical resources of computing devices external to host device 100.

VM(s) 110 are compute resources that use software instead of a physical computing device to execute and deploy applications. VM(s) 110 comprise guest OS 112A, 112B, and 112C (collectively referred to as “guest OS 112”). Each guest OS 112 comprises a kernel space and a user space. The kernel space is reserved for executing a privileged OS kernel, kernel extensions, and most device drivers. The user space is reserved for executing application software and non-privileged device drivers. In examples, guest OS 112 implements or has access to applications, such as described with respect to host applications 106. Each guest OS 112 may comprise or provide access to a different set of applications.

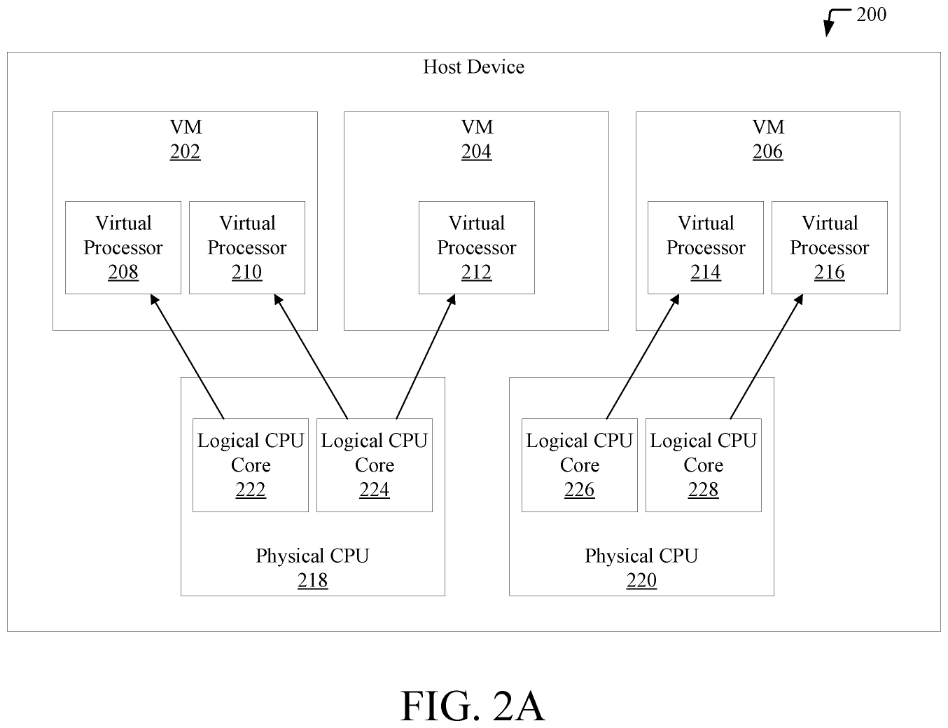

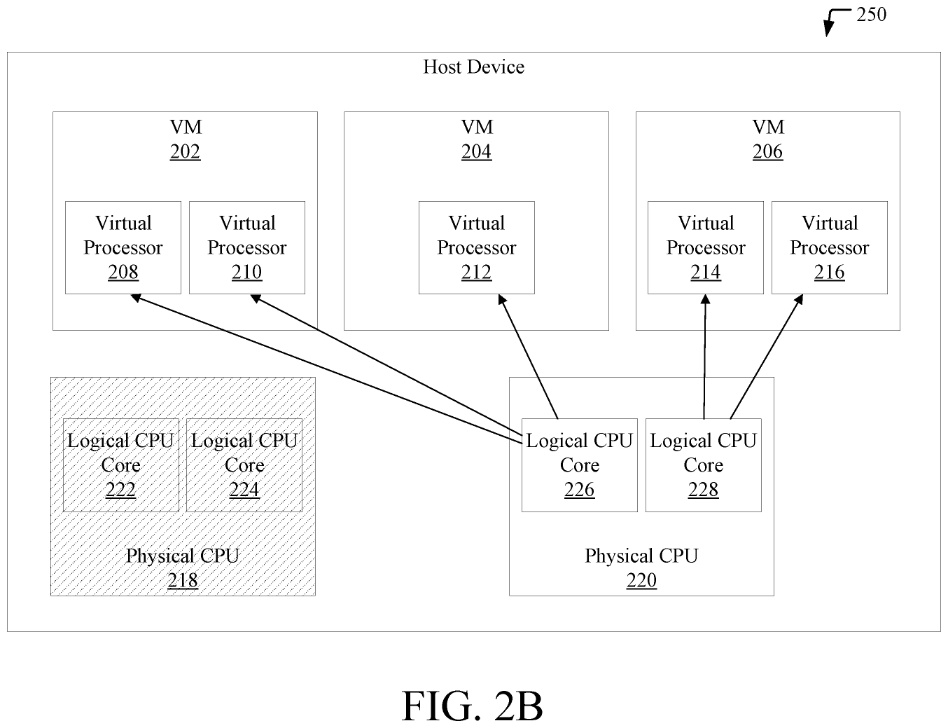

FIGS. 2A and 2B illustrate example mappings of virtual processors to logical CPU cores. FIG. 2A illustrates example first mapping 200, in which no physical CPUs have been off-parked. Mapping 200 is implemented by host device 201. Host device 201 comprises VM 202, VM 204, and VM 206. VM 202 comprises virtual processor 208 and virtual processor 210. VM 204 comprises virtual processor 212. VM 202 comprises virtual processor 214 and virtual processor 216. Example host device 200 further comprises physical CPU 218 and physical CPU 220. Physical CPU 218 comprises logical CPU core 222 and 224. Physical CPU 220 comprises logical CPU core 226 and 228.

In mapping 200, logical CPU core 222 is mapped to virtual processor 208. Logical CPU core 224 is mapped to virtual processor 210 of VM 202 and virtual processor 212 of VM 204. Logical CPU core 226 is mapped to virtual processor 214. Logical CPU core 228 is mapped to virtual processor 216.

FIG. 2B illustrates example second mapping 250, in which a physical CPU has been off-parked. In mapping 250, physical CPU 218 has been off-parked by host device 201 or a component thereof, such as a hypervisor. Accordingly, physical CPU 218, logical CPU core 222, and logical CPU core 224 are no longer available to process workloads of VM 202 and VM 204. The off-parking of physical CPU 218 is denoted by the diagonal fill lines.

In response to the off-parking of physical CPU 218, logical CPU core 226 and logical CPU core 228 of physical CPU 220 have been remapped to process workloads of VM 202 and VM 204. Specifically, logical CPU core 226 has been remapped to virtual processor 208, virtual processor 210, and virtual processor 212. Logical CPU core 228 has been remapped to virtual processor 214 and virtual processor 216.

Having described one or more devices and systems that may employ aspects of the present disclosure, one or more methods for performing these aspects will now be described. In examples, method 300 may be executed by a device, such as host device 100. However, method 300 is not limited to such examples. In other aspects, one or more steps in method 300 is performed by an alternative computing system or device.

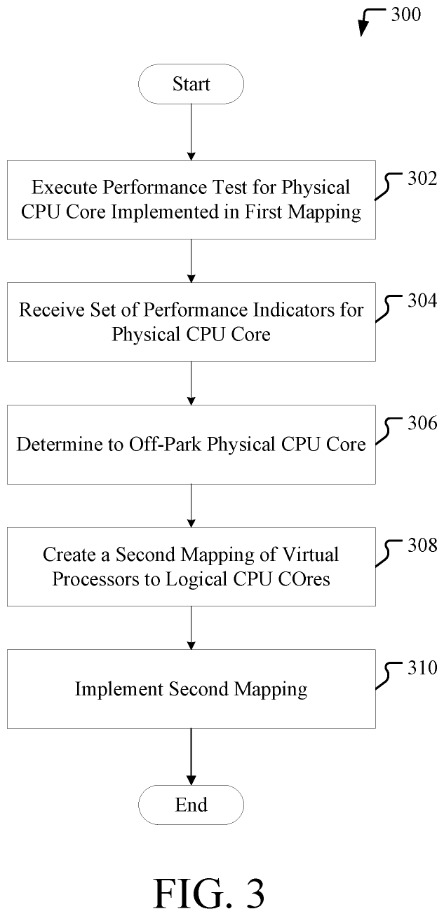

FIG. 3 illustrates an example method for CPU core off-parking. Example method 300 begins at operation 302, where a performance test is executed for a CPU core of a host device, such as host device 100. The CPU core may be a physical CPU core or a virtual CPU core (“virtual processor”) and the host device may, but need not, comprise a virtual environment. The CPU core is part of a first mapping of virtual processors of a VM to logical CPU cores of a host device, such as mapping 200. In examples, the performance test is executed using testing software implemented by a component of the host device, such as an OS kernel (executing with or without a hypervisor), a hypervisor, or a processor power management component. Executing the performance test may comprise causing the CPU core to execute a set of commands or instructions that generate CPU metrics. Executing the performance test may also comprise accessing recorded data related to the CPU core, such as performance logs and alert logs for the host device and/or a VM associated with the CPU core. For instance, a VM to which one or more logical CPU cores of a physical CPU core have been allocated may store virtual processor performance data in various VM logs. The recorded data related to the CPU core indicates CPU error data, warnings, and similar notifications.

At operation 304, a set of performance indicators is received for the CPU core. The set of performance indicators is provided by the testing software in response to the performance test. In examples, the set of performance indicators includes CPU metrics for the CPU core. Examples of CPU metrics include availability, response time, channel capacity, latency, completion time, service time, bandwidth, throughput, relative efficiency, scalability, performance per watt, compression ratio, instruction path length, voltage, current, power/energy, and temperature. The set of performance indicators may also include the number of errors reported for the CPU core (e.g., corrected errors, fatal errors, an internal errors), the frequency of errors reported for the CPU core, the length of the time the CPU core has been in use, and other factors. In examples, the performance indicators are indicative of the current and historical performance of the CPU core.

At operation 306, a determination is made that the CPU core is to be off-parked. In examples, the determination is made by an OS kernel running without a hypervisor on a host device, an OS kernel running with a hypervisor in a VM, a hypervisor running on a host device, or a second hypervisor running nested on a first hypervisor in a VM. Determining the CPU core is to be off-parked includes comparing the set of performance indicators to a set of parameters indicating threshold values for the set of performance indicators. The threshold values may correspond to lifetime values or values over a predefined range of time. For instance, a threshold value may indicate that a CPU core is defective if twenty (20) fatal errors have been detected for the CPU core over the lifetime of the CPU core. Alternatively, a threshold value may indicate that a CPU core is likely to encounter an imminent failure if five (5) fatal errors have been detected for the CPU core during any consecutive seven-day period. In examples, the determination may be performed manually or using automated software techniques, such as machine learning.

At operation 308, a second mapping of virtual processors to logical CPU cores is created, such as mapping 250. The second mapping is created based on factors such as historical performance statistics of the physical CPU cores (e.g., the virtual processors that were mapped to an off-parked physical CPU core are remapped to a physical CPU core having the lowest CPU load over a period of time), a predefined remapping scheme (e.g., if physical CPU core 1 fails, remap any virtual processors mapped to physical CPU core 1 to physical CPU core 5), the virtual topology of a VM (e.g., whether the VM utilizes hyperthreading, simultaneous multithreading, non-uniform memory access, or other performance considerations. In the second mapping, the logical CPU cores of the physical CPU core to be off-parked are removed and the logical CPU cores of one or more alternative physical CPU cores are mapped to the virtual processors that were previously mapped to the logical CPU cores of the physical CPU core to be off-parked. Alternatively, a virtual processor to be off-parked is removed from the second mapping and a replacement virtual processor is mapped to the logical CPU cores of one or more physical CPUs. The second mapping is then used to overwrite the first mapping or update the first mapping to the second mapping.

The remapping of the virtual processors and the logical CPU cores from the first mapping to the second mapping enables defective CPU cores to be removed from workload processing without impact to the VMs or the host device. For instance, a VM processes workloads on a virtual processor of the VM. The VM is not aware of a physical CPU core that is mapped to the virtual processor. When the physical CPU core that is mapped to the virtual processor is off-parked, a separate physical CPU core is mapped to the virtual processor. The VM simply continues to provide workloads to the virtual processor without being aware of, or needing to be reconfigured to handle, the new physical CPU core, and the hypervisor prevents or significantly reduces the scheduling of virtual processor threads on the off-parked physical CPU core. In another example, an application processes workloads on a physical CPU of a host device executing without a hypervisor. The application is not aware of the physical CPU core. When the physical CPU core is off-loaded, the workloads are provided to one or more alternative physical CPUs, and the application simply continues to provide workloads to the alternative CPU(s) without being aware of, or needing to be reconfigured to handle, the alternative CPU(s). The OS kernel of the host device prevents or significantly reduces the scheduling of application threads on the off-parked physical CPU core.

At operation 310, the second mapping is implemented by the host device. Implementing the second mapping comprises executing workloads of a VM in accordance with the second mapping. For example, a virtual processor that previously processed workloads using a logical CPU core of the off-parked physical CPU core will begin processing the workloads using a logical CPU core of a different physical CPU core in accordance with the second mapping. As such, the hypervisor can effectively ignore the off-parked physical CPU core when workloads are being allocated to the virtual processors. Alternatively, the hypervisor can place the off-parked physical CPU core in an emergency role such that the off-parked physical CPU core will only receive workloads when no other physical CPU cores are available or when the combined processing load of the physical CPU cores exceeds a threshold level.

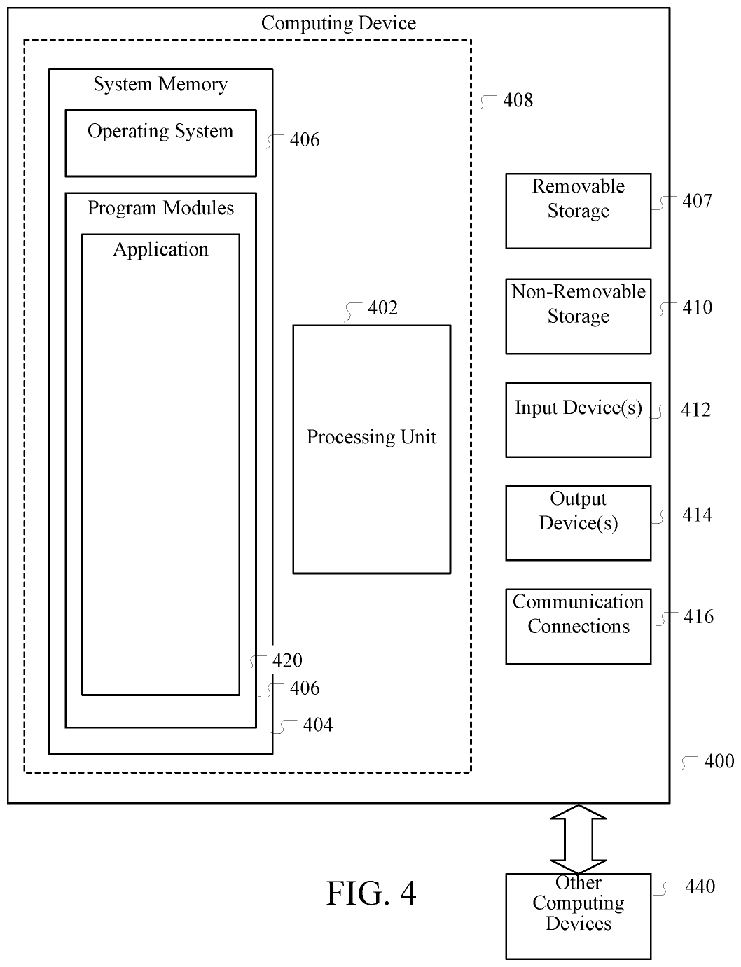

FIGS. 4-7 and the associated descriptions provide a discussion of a variety of operating environments in which aspects of the disclosure may be practiced. However, the devices and systems illustrated and discussed with respect to FIGS. 4-7 are for purposes of example and illustration, and, as is understood, a vast number of computing device configurations may be utilized for practicing aspects of the disclosure, described herein.

FIG. 4 is a block diagram illustrating physical components (e.g., hardware) of a computing device 400 with which aspects of the disclosure may be practiced. The computing device components described below may be suitable for the computing devices and systems described above. In a basic configuration, the computing device 400 includes at least one processing system 402 and a system memory 404. Depending on the configuration and type of computing device, the system memory 404 may comprise volatile storage (e.g., random access memory), non-volatile storage (e.g., read-only memory), flash memory, or any combination of such memories.

The system memory 404 includes an operating system 405 and one or more program modules 406 suitable for running software application 420, such as one or more components supported by the systems described herein. The operating system 405, for example, may be suitable for controlling the operation of the computing device 400.

Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 407 and a non-removable storage device 410.

As stated above, a number of program modules and data files may be stored in the system memory 404. While executing on the processing system 402, the program modules 406 (e.g., application 420) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 400 may also have one or more input device(s) 412 such as a keyboard, a mouse, a pen, a sound or voice input device, a touch or swipe input device, etc. The output device(s) 414 such as a display, speakers, a printer, etc. may also be included. The aforementioned devices are examples and others may be used. The computing device 400 may include one or more communication connections 416 allowing communications with other computing devices 450. Examples of suitable communication connections 416 include radio frequency (RF) transmitter, receiver, and/or transceiver circuitry; universal serial bus (USB), parallel, and/or serial ports.

The term computer readable media as used herein includes computer storage media. Computer storage media includes volatile and nonvolatile, removable and non-removable media implemented in any method or technology for storage of information, such as computer readable instructions, data structures, or program modules. The system memory 404, the removable storage device 407, and the non-removable storage device 410 are all computer storage media examples (e.g., memory storage). Computer storage media includes random access memory (RAM), read-only memory (ROM), electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

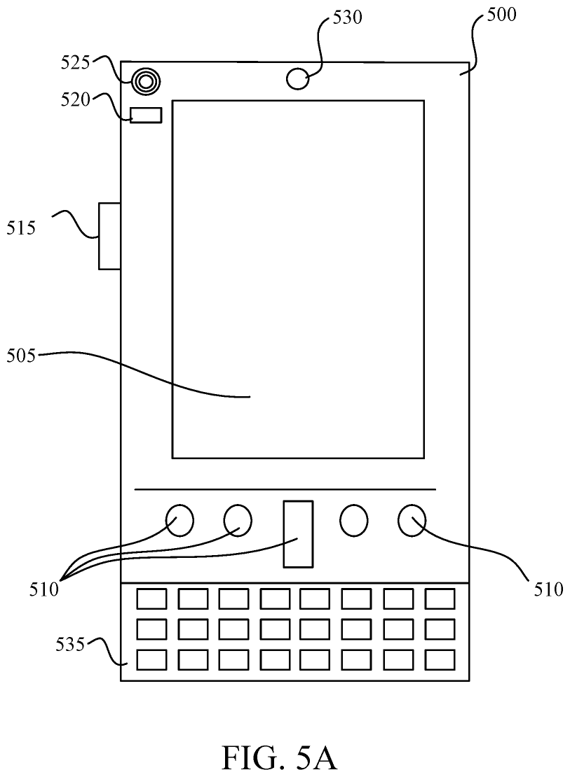

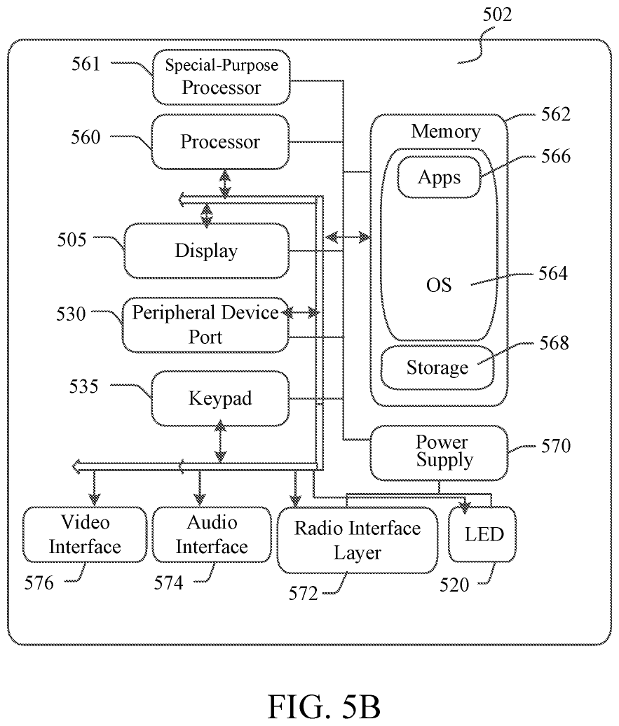

FIGS. 5A and 5B illustrate a mobile computing device 500, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display).

If included, an optional side input element 515 allows further user input. The side input element 515 may be a rotary switch, a button, or any other type of manual input element. In alternative aspects, mobile computing device 500 may incorporate more or less input elements. For example, the display 505 may not be a touch screen in some embodiments.

In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display.

In various embodiments, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device 500 can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500 described herein (e.g., search engine, extractor module, relevancy ranking module, answer scoring module).

The system 502 has a power supply 570, which may be implemented as one or more batteries. The power supply 570 might further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator (e.g., light emitting diode (LED) 520) may be used to provide visual notifications, and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor(s) (e.g., processor 560 and/or special-purpose processor 561) and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone may also serve as an audio sensor to facilitate control of notifications, as will be described below. The system 502 may further include a video interface 576 that enables an operation of a peripheral device port 530 (e.g., an on-board camera) to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data/information may be readily transferred between computing devices for storage and use according to well-known data/information transfer and storage means, including electronic mail and collaborative data/information sharing systems.

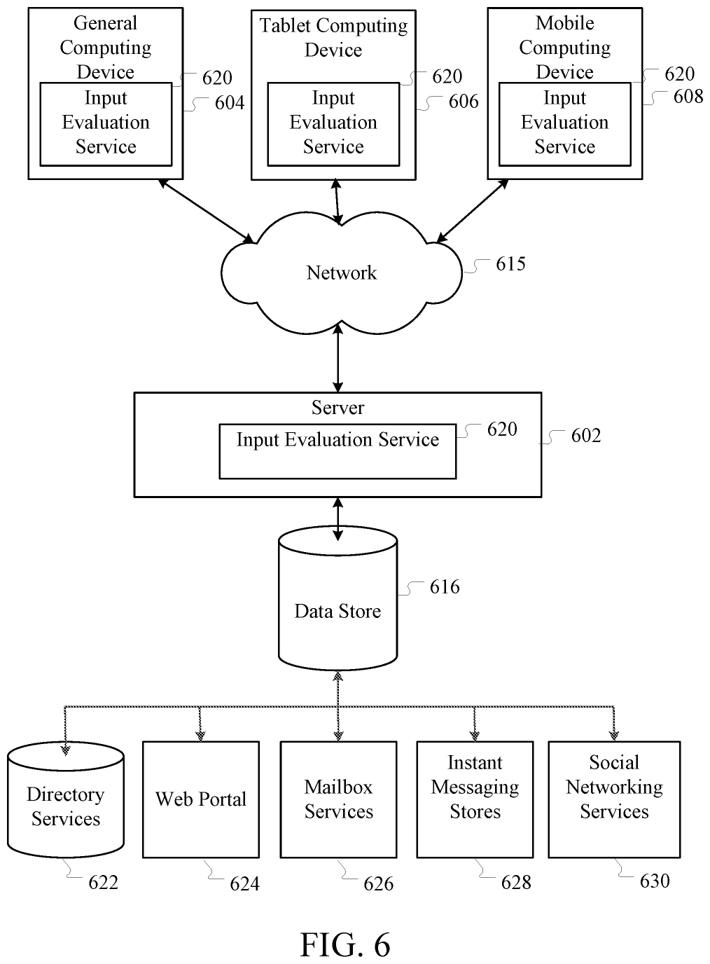

FIG. 6 illustrates one aspect of the architecture of a system for processing data received at a computing system from a remote source, such as a personal computer 604, tablet computing device 606, or mobile computing device 608, as described above. Content displayed at server device 602 may be stored in different communication channels or other storage types. For example, various documents may be stored using a directory service 622, a web portal 624, a mailbox service 626, an instant messaging store 628, or a social networking site 630.

An input evaluation service 620 may be employed by a client that communicates with server device 602, and/or input evaluation service 620 may be employed by server device 602. The server device 602 may provide data to and from a client computing device such as a personal computer 604, a tablet computing device 606 and/or a mobile computing device 608 (e.g., a smart phone) through a network 615. By way of example, the computer system described above may be embodied in a personal computer 604, a tablet computing device 606 and/or a mobile computing device 608 (e.g., a smart phone). Any of these embodiments of the computing devices may obtain content from the store 616, in addition to receiving graphical data useable to be either pre-processed at a graphic-originating system, or post-processed at a receiving computing system.

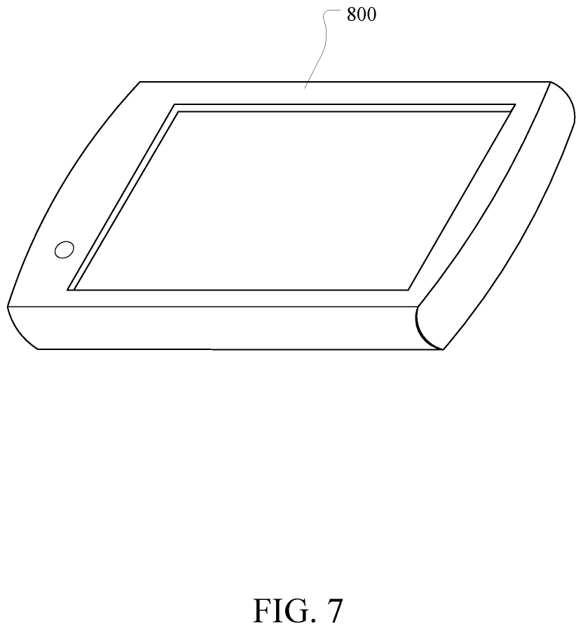

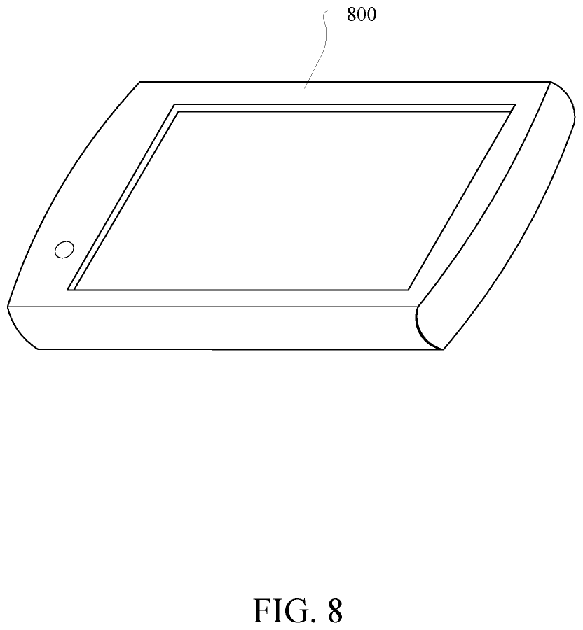

FIG. 7 illustrates an example of a tablet computing device 700 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one example of the technology relates to a computer-implemented method. The method comprises: generating a set of performance indicators for a physical central processing unit (CPU) that is malfunctioning by executing a performance test on the physical CPU core, wherein the physical CPU core is included in a first mapping of virtual processors to logical CPU cores; based on the set of performance indicators, determining the physical CPU core is to be off-parked; creating a second mapping of virtual processors to logical CPU cores, wherein the physical CPU core is not mapped to any of the virtual processors in the second mapping; and implementing the second mapping.

In another example, the technology relates to a system comprising: memory comprising computer executable instructions that, when executed, perform operations comprising: generating a set of performance indicators for a first physical central processing unit (CPU) that is malfunctioning by executing a performance test on the first physical CPU core, the first physical CPU core being associated with a first logical CPU core, wherein a first mapping correlates the first logical CPU core to a virtual processor of a virtual machine; based on the set of performance indicators, off-parking the first physical CPU core; creating a second mapping, wherein the second mapping correlates a second logical CPU core associated with a second physical CPU core to the virtual processor of the virtual machine; and implementing the second mapping.

In another example, the technology relates to a device comprising: memory comprising computer executable instructions that, when executed, perform operations comprising: receiving a set of performance indicators for a first physical central processing unit (CPU) core that is malfunctioning by executing a performance test on the first physical CPU core, the first physical CPU core being associated with a set of logical CPU cores, a first mapping correlating the set of logical CPU cores to virtual processors of a set of virtual machines, the first physical CPU core being implemented in a host device comprising a virtual machine; based on the set of performance indicators, determining the physical first CPU core is to be off-parked; creating a second mapping, wherein the second mapping correlates a second logical CPU core associated with a second physical CPU core to the virtual processors of the set of virtual machines; and implementing the second mapping.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method comprising:
generating a set of performance indicators for a physical central processing unit (CPU) that is malfunctioning by executing a performance test on the physical CPU core, wherein the physical CPU core is included in a first mapping of virtual processors to logical CPU cores;
based on the set of performance indicators, determining the physical CPU core is to be off-parked;
creating a second mapping of virtual processors to logical CPU cores, wherein the physical CPU core is not mapped to any of the virtual processors in the second mapping; and
implementing the second mapping.

2. The method of claim 1, wherein the physical CPU core is implemented by a host device, the host device comprising a virtual machine.

3. The method of claim 2, wherein the virtual processors are implemented by the virtual machine to execute workloads of the virtual machine.

4. The method of claim 2, wherein the performance test is executed by a hypervisor of the host device, wherein the hypervisor manages the virtual machine.

5. The method of claim 1, wherein the logical CPU cores represent a number of threads that can be executed by the physical CPU core.

6. The method of claim 1, wherein executing the performance test comprises causing the physical CPU core to execute a set of commands or instructions that generate CPU metrics for the physical CPU core.

7. The method of claim 1, wherein executing the performance test comprises accessing performance logs or alert logs for the physical CPU core.

8. The method of claim 1, wherein set of performance indicators comprises CPU metrics for the physical CPU core, the CPU metrics comprising at least one of:
availability;
response time; or
service time.

9. The method of claim 8, wherein the CPU metrics further comprise at least one of:
channel capacity;
bandwidth; or
relative efficiency.

10. The method of claim 1, wherein set of performance indicators comprises at least one of:
a number of errors reported for the physical CPU core;
a frequency of errors reported for the physical CPU core; or
a length of the time the physical CPU core has been in use.

11. The method of claim 1, wherein determining the physical CPU core is to be off-parked comprises comparing the set of performance indicators to a set of parameters indicating threshold values for the set of performance indicators.

12. The method of claim 11, wherein performance indicators in the set of performance indicators that exceed the threshold values indicate the physical CPU core is currently defective.

13. The method of claim 1, wherein:
the first mapping comprises a first logical CPU core for the physical CPU core, the physical CPU core belonging to a first CPU; and
the first logical CPU core is mapped to a virtual processor of a virtual machine.

14. The method of claim 13, wherein creating the second mapping of virtual processors to logical CPU cores comprises:
mapping the virtual processor of the virtual machine to a second logical CPU core of an alternative physical CPU core.

15. The method of claim 1, wherein implementing the second mapping comprises off-parking the physical CPU core.

16. A system comprising:
memory comprising computer executable instructions that, when executed, perform operations comprising:
generating a set of performance indicators for a first physical central processing unit (CPU) that is malfunctioning by executing a performance test on the first physical CPU core, the first physical CPU core being associated with a first logical CPU core, wherein a first mapping correlates the first logical CPU core to a virtual processor of a virtual machine;
based on the set of performance indicators, off-parking the first physical CPU core;
creating a second mapping, wherein the second mapping correlates a second logical CPU core associated with a second physical CPU core to the virtual processor of the virtual machine; and
implementing the second mapping.

17. The system of claim 16, wherein off-parking the physical CPU core comprises disabling the physical CPU core.

18. The system of claim 16, wherein off-parking the physical CPU core comprises placing the physical CPU core into an emergency role such that the off-parked physical CPU core receives workloads when no other physical CPU cores are available.

19. The system of claim 16, wherein implementing the second mapping comprises:
replacing the first mapping with the second mapping; and
executing workloads of the virtual machine in accordance with the second mapping.

20. A device comprising:
memory comprising computer executable instructions that, when executed, perform operations comprising:
receiving a set of performance indicators for a first physical central processing unit (CPU) core that is malfunctioning by executing a performance test on the first physical CPU core, the first physical CPU core being associated with a set of logical CPU cores, a first mapping correlating the set of logical CPU cores to virtual processors of a set of virtual machines, the first physical CPU core being implemented in a host device comprising a virtual machine;
based on the set of performance indicators, determining the physical first CPU core is to be off-parked;
creating a second mapping, wherein the second mapping correlates a second logical CPU core associated with a second physical CPU core to the virtual processors of the set of virtual machines; and
implementing the second mapping.
